(19) United States
(12) Patent Application Publication
(10) Pub. No.: US 2011/0215724 A1
(43) Pub. Date: Sep. 8, 2011

(54) SYSTEM AND METHODS OF INTELLIGENT ON/OFF MODES AND DIMMING FUNCTIONALITY FOR LIGHTING DEVICES

(76) Inventors: Jyotirmoy Chakravarty, Boerne, TX (US); Sarosij Sengupta, Gurgaon (IN)

(21) Appl. No.: 12/898,014

(22) Filed: Oct. 5, 2010

Related U.S. Application Data
(60) Provisional application No. 61/309,879, filed on Mar. 3, 2010.

(51) Int. Cl. H05B 37/02

(52) U.S. Cl. 315/152; 315/294

(57) ABSTRACT

The present invention provides a system for intelligently controlling the ON/OFF modes and dimming functionality for lighting devices with built in redundancy. The system comprises: a plurality of sensor banks having a plurality of sensors capable of operating over exclusive ambient light levels and creating redundancy; and a micro-controller configured to add dimming functionality and automatically detecting faulty sensing situations and sudden change in the light level, wherein computing logics are adapted with the help of a high end micro-controller to increase sensitivity of the system.

### CROSS-REFERENCE TO RELATED APPLICATION

This non-provisional patent application claims priority from the U.S. provisional patent application Ser. No. 61/309,879 filed on Mar. 3, 2010, the content of which is incorporated herein by reference.

### FIELD OF THE INVENTION

The present invention relates generally lighting devices, and more particularly, to system and methods for controlling the ON/OFF modes and dimming functionality of outdoor lights in a low cost, convenient, environmentally safe, intelligent, highly reliable and cost effective manner.

### BACKGROUND OF THE INVENTION

Earlier outdoor lights were all about different types of light distribution corresponding to the type to usage and coverage area. With the introduction of LED luminaires, the concept of every saving became one of the most important parameter for illuminating equipments. But today a luminaire is considered incomplete without the capability of automated ON/OFF control and is the most sought after criteria apart from light pattern and percentage energy saving.

Now a days, the most preferred method of controlling the ON/OFF modes of outdoor lights, e.g., street lights, in the industry is by using bi-metal strip relay, LDR based sensors, which automatically switches ON and OFF the out-door lights, such as street lights, parking and other outdoor lights, by sensing the lumens/ambient light as opposed to centrally or manually controlled power switches.

Although the presently available photos sensors are capable of providing the required ON/OFF functionality, but ironically the same photo sensors are also the weakest link in the lighting system for a number of reasons, including: the photo sensor is a costly item to replace; the current photo sensors use discrete components with expansion metal relays which have a very short life/MTBF and hence needs frequent replacements which further make them expensive; photo sensors switch the outdoor lights ON and OFF based on a fixed threshold value of ambient light which cannot be altered as per requirement without a design modification; the actual power consumption is much higher than required as these sensors would switch on the light only to full power consumption mode (i.e. full light output) even though a lower light output is adequate at that particular ambient light; as the sensors systems do not carry any intelligence therefore they are not capable of differentiating sudden low light levels for reasons like passing clouds, momentary light blocks due to birds etc.

As an answer to the complaints of frequent replacement of photo sensors screw on replacement sensors were introduced in the market. This approach reduces the time to replace the sensor, however, the approach still does not prevent a maintenance call which turns out to be expensive because a bucket truck has to be sent out to reach the top of the pole and the hourly rate on that is high.

Although the prior art discloses different techniques for controlling the ON/OFF modes and dimming functionality of outdoor lights, but the features of the conventional techniques for controlling the ON/OFF modes and dimming functionality of outdoor lights, disclose complex designs and bulky structural indices that hinder their performance. Many such techniques are too complex for reliable operation and fail to provide efficient means for controlling the ON/OFF modes and dimming functionality of outdoor lights. No such system or technique is available in the commercial market at the present time which is capable of making the ambient light sensing capability intelligent and more reliable by putting in computing capability and using chip based sensor with high life expectancy.

In view of the disadvantages inherent in the conventional means of controlling the ON/OFF modes of street lights in the industry, it has remained a constant concern to provide for more practical, more efficient system and method for making the ambient light sensing capability intelligent and more reliable by putting in computing capability and using chip based sensor with high life expectancy and also controlling the ON/OFF modes and dimming functionality of outdoor lights, in a convenient, environmentally safe, and cost effective manner.

### SUMMARY FOR THE INVENTION

In view of the foregoing disadvantages inherent in the prior arts, the general purpose of the present invention is to provide an improved combination of convenience and utility, to include the advantages of the prior art, and to overcome the drawbacks inherent in the prior art. Therefore, the task of the inventions is to increase the achievable productivity and its economic efficiency.

The present invention provides an effective system and method for controlling the ON/OFF modes and dimming functionality of outdoor lights in an environmentally safe, convenient, and cost effective manner.

In one aspect, the present invention comprises: at least a multiple sensor bank capable of creating redundancy, increasing life of the sensor based system, reducing maintenance cost; at least a sensor in each sensor bank for increasing sensitivity of the sensor based system and making the system highly precise; and at least a highly powerful micro-controller capable of implanting intelligence into the lights, making the light a true power saving unit by adding dimming functionality, and detecting faulty sensing created by passing by objects using sampling module.

In another aspect, the present invention provides a system for intelligently controlling the ON/OFF modes and dimming functionality for lighting devices with built in redundancy. The system comprises: at least a sensor bank having a plurality of sensors capable of operating over exclusive ambient light levels and creating redundancy; at least a micro-controller configured to add dimming functionality and automatically detecting faulty sensing situations and sudden change in the light level; a polling module capable of detecting the conditions of the sensors and building redundancy; and a sampling module capable of controlling light output based on detected ambient light conditions and ambiguous false detections conditions. A time based dimming module is capable of working as disaster recovery in case of failure of all sensors. The micro-controller uses the sampling module to average out the results captured over a period of approximate 15-30 seconds to remove all possibilities of false reading captured due to sudden light level changes.

In another aspect, the present invention provides a method for intelligently controlling the ON/OFF modes and dimming functionality for lighting devices with built in redundancy. The method comprises the steps of: initializing a data memory and digital and analog pins; running polling module; initializing and switching to time based dimming in case the sensor bank is not working; and running a sampling module if the sensor bank is working.

In another aspect of the present invention, the polling module comprises the steps of: reading analog voltage signals coming from sensor banks and converting the analog voltage signals to digital voltage signals; checking digital voltage; checking sensor bank failure detection; marking the failure sensor bank for not reading failed sensor bank further; reading the working sensor bank in order to built the redundancy; switching to time based module if both sensor banks are failed; averaging out the digital voltages read from the sensor banks; storing the data in internal memory of the micro-controller; checking whether desired samples are collected over 15-20 seconds or not; terminating the polling module in case desired samples are collected; and starting a sampling module for controlling light output based on detected ambient light conditions and also removing ambiguous false condition detections.

In another aspect of the present invention, the sampling module comprises the steps of: studying all the data samples collected and stored in an internal memory of the micro-controller during the polling module to check consistent ambient light change; and setting an actual duty cycle by referring to a voltage versus duty cycle table stored in the non-volatile memory of the micro-controller.

In another aspect, the present invention provides a system for intelligently controlling the ON/OFF modes and dimming functionality for lighting devices with built in redundancy. The system comprises: a plurality of sensor banks having a plurality of sensors capable of operating over exclusive ambient light levels and creating redundancy; and a micro-controller configured to add dimming functionality and automatically detecting faulty sensing situations and sudden change in the light level, wherein computing logics are adapted with the help of a high end micro-controller to increase sensitivity of the system.

An another aspect, the present invention provides a highly sensitive, precise, intelligent and programmable ON/OFF and dimming functionality for outdoor lights with built in redundancy using a combination of microcontroller and ambient light photo sensors.

An another aspect, the present invention comprises means to increase a MTBF of the photo sensor based control by providing a feasible method of implementing sensor redundancy on each light system and/or by eliminating the use of low life expectancy metal relays.

These together with other aspects of the present invention, along with the various features of novelty that characterize the invention, are pointed out with particularity in the detailed description forming a part of this disclosure. For a better understanding of the present invention, its operating advantages, and the specific objects attained by its uses, reference should be made to the accompanying drawings and descriptive matter in which, there are illustrated exemplary embodiments of the present invention.

### BRIEF DESCRIPTION OF THE DRAWINGS

The advantages and features of the present invention will become better understood with reference to the following more detailed description taken in conjunction with the accompanying drawings, in which like elements are identified with like symbols, and in which:

FIG. 1 illustrates an exploded view of the chip sensors and the microcontroller assembly arrangement within the casing top and bottom parts, according to a prior art work;

FIG. 2 illustrates a block diagram of a system for, according to an exemplary embodiment of the present invention;

FIG. 3 illustrates a graph between relative spectral sensitivity and wavelength, according to an exemplary embodiment of the present invention;

FIG. 4 illustrates a illuminance versus photocurrent characteristics of chip sensors or photodiodes, according to an exemplary embodiment of the present invention;

FIG. 5 illustrates a circuit with multiple sensors and auxiliary, according to an exemplary embodiment of the present invention;

FIG. 6 illustrates a plurality of sensor banks connected with a micro-controller to build in a redundancy, according to an exemplary embodiment of the present invention;

FIG. 7 illustrates the sensor bank, according to an exemplary embodiment of the present invention;

FIG. 8 is a flow graph of a method for controlling the ON/OFF modes and dimming functionality, according to an exemplary embodiment of the present invention;

FIG. 9 is a flow graph of the functioning of a polling module, according to an exemplary embodiment of the present invention; and

FIG. 10 is a flow graph of functioning of a sampling module according to an exemplary embodiment of the present invention.

Like reference numerals refer to like parts throughout several views of the drawings of the present invention.

### DETAILED DESCRIPTION OF THE INVENTION

The exemplary embodiments described herein detail for illustrative purposes are subject to many variations and structure and design. It should be emphasized, however that the present invention is not limited to a particular system and methods for controlling intelligently the ON/OFF modes and dimming functionality of out door lights as shown and described. Rather, the principles of the present invention can be used with a variety of configurations and structural arrangements for controlling the ON/OFF modes and dimming functionality of out door lights. It is understood that various omissions, substitutions of equivalents are contemplated as circumstances may suggest or render expedient, but the present invention is intended to cover the application or implementation without departing from the spirit or scope of the it's claims.

In the following description, for purposes of explanation, numerous specific details are set forth in order to provide a thorough understanding of the present invention. It will be apparent, however, to one skilled in the art that the present invention may be practiced without these specific details.

As used herein, the term ‘computing logic’ or ‘module’ refers to ‘algorithms’, the term ‘light-source’ refers to any semiconductor light source including LEDs, laser diodes, quantum dots or any combination thereof, the term ‘fixture’ refers to housing or compartment, the term ‘plurality’ refers to the presence of more than one of the referenced item, and the terms ‘a’ and ‘an’ do not denote a limitation of quantity but rather denote the presence of at least one of the referenced item.

The present invention provides an effective system and method for controlling the ON/OFF modes and dimming functionality of out door lights in an environmentally safe, intelligent, highly reliable, convenient, and cost effective manner; to include advantages of the existing system and methods, and to overcome the drawbacks inherent therein. The task of the inventions is to increase the achievable productivity and its economic efficiency.

The present invention provides a highly sensitive, precise, intelligent and programmable ON/OFF and dimming functionality for outdoor LED illuminating equipment with built in redundancy using a combination of microcontroller and ambient light chip based photo sensors. The fundamental idea of the invention is to make the ambient light sensing capability intelligent and more reliable by putting in computing capability and using chip based sensor with high life expectancy.

Referring to FIG. 1 which illustrates an exploded view of the chip sensors 3 and the micro-controller assembly 7 arrangement within the casing top 2 and bottom parts 9, according to a prior art work. All the electronic components like ICs, resistors, capacitors along with the programming port for the microcontroller 6 are placed on the Daughter card printed circuit board 4 which is covered with a polycarbonate lens 1 used for protecting the sensors and also has high refractive index to avoid ambient light losses. The microcontroller interacts with the parent driver circuit board 8 to control ON/OFF and dimming using a wire harness interconnection 5.

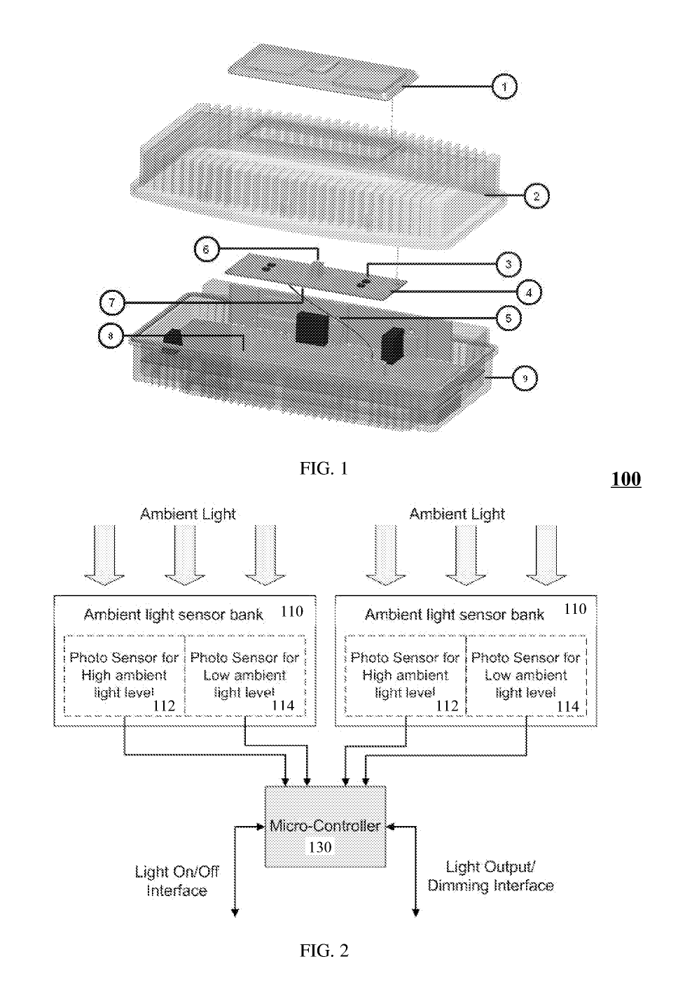

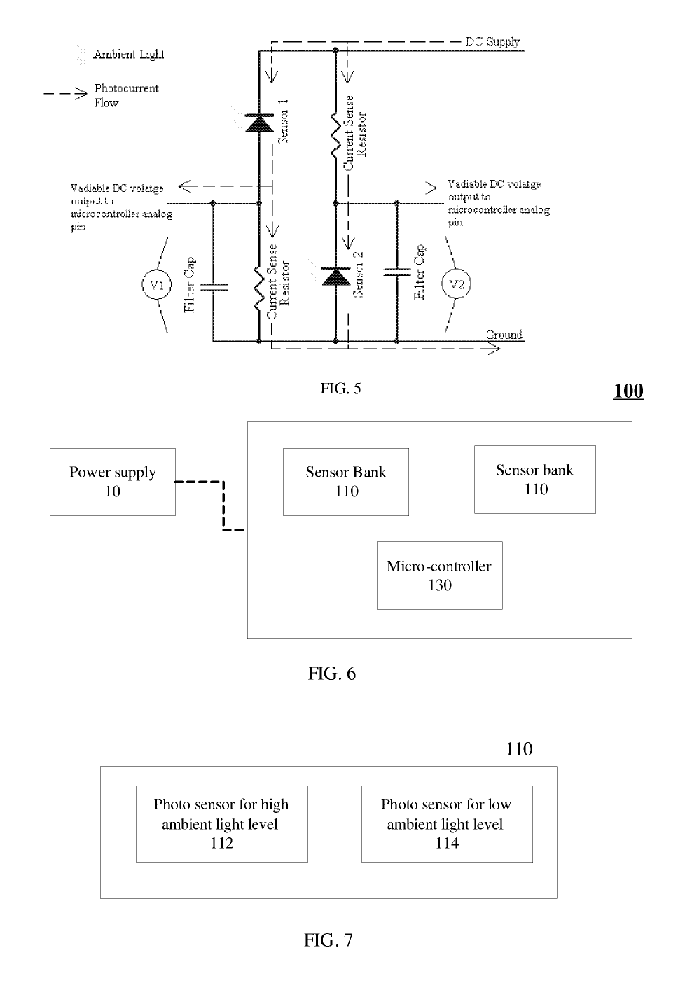

Referring to FIG. 2 which illustrates a block diagram of a system 100 for intelligently controlling the ON/OFF modes and dimming functionality of outdoor lights, according to an exemplary embodiment of the present invention. The system 100 comprises at least a sensor bank 110 connected with at least a micro-controller 130. The sensor bank 110 may have at least an ambient light sensor which may be a chip based sensor. The ambient light sensor (also referred to as ‘chip sensors’) may be at least any one of a sensor for high ambient light level 112, a sensor for low ambient light level 114 or any combination thereof. The sensor bank 110 is capable of creating redundancy, increasing the life and reducing operational cost of the system 100. The sensors for high ambient light level 112 and the sensor for low ambient light level 114 in the sensor bank 110 are capable of increasing sensitivity of the system 100 and making the system 100 highly precise. The sensors for high ambient light level 112 and the sensor for low ambient light level 114 may include chip based sensors and photo sensors. The micro-controller 130 may be a highly powerful micro-controller which is capable of implanting intelligence into the lights. The micro-controller 130 may be connected with a light output/dimming interface and light ON/OFF interface, and power supply 10 (as shown in FIG. 6) The micro-controller 130 is capable of making the light a true power saving unit by adding dimming functionality. Further, the micro-controller 130 is capable of detecting faulty sensing situations created due to passing by objects. The micro-controller 130 may use sampling algorithm (also referred to as ‘sampling module’) to detect faulty sensing situations. The lights include out door lights, street lights, public lights.

According to an exemplary embodiment, the present invention provides system and methods to resolve the present day challenges and weaknesses of the expansion metal relay based automated ON/OFF control systems 100 for outdoor illuminating equipment by using a plurality of sensor bank 100. The system 100 is enabled with computing logics or modules/algorithms with the help of the high end micro-controller 130.

According to an exemplary embodiment of the present invention, the system 100 is an ambient light based sensor system or chip based sensor system which may includes at least the ambient light sensor or the chip based sensor or photo diode. The chip based sensors may be used instead of the expansion metal relay sensors to increase the life of the sensor system which is one of the major problems faced today. These chip based sensors have a life almost comparable with the solid state lighting system which ranges between 50K to 60K hours. Therefore the chip based sensors may not need frequent field replacements thereby reducing the maintenance cost of the outdoor illuminating equipments.

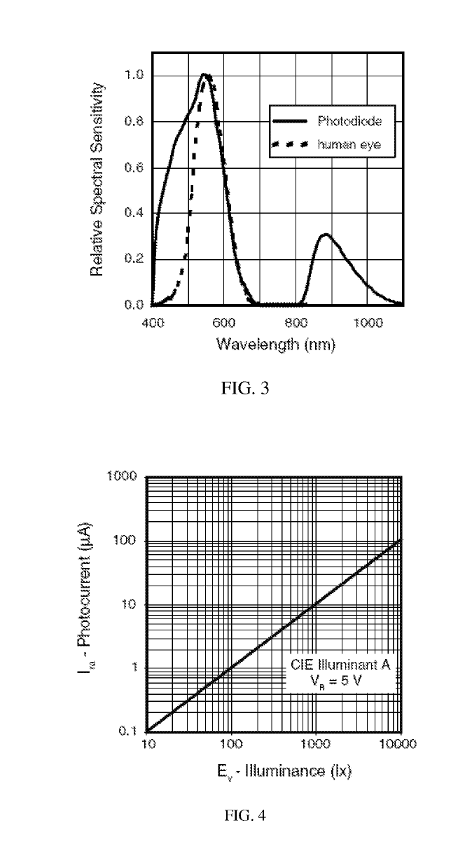

Referring to FIG. 3 which illustrates a graph between relative spectral sensitivity and wavelength, according to an exemplary embodiment of the present invention. The present invention may involves a dimming capability which may controls the light output of the illuminating equipments based on the amount of instantaneous ambient light level. The basic criteria based on which the sensors are selected is their behaviour to ambient light. The chip based sensor may use a PIN photodiode with high photo sensitivity in a miniature surface mount device (also known as ‘SMD’), for example, the detector chip may has a 7.5 mm² sensitive area and is sensitive to visible light much like the human eye with peak sensitivity at 540 nm. The graph plot of FIG. 3 demonstrates the relative spectral sensitivity versus wavelength.

Referring to FIG. 4 illustrates an illuminance versus photocurrent characteristics of chip based sensors or photodiodes, according to an exemplary embodiment of the present invention. These chip based sensors or photodiodes due to their structural characteristics follow an illuminance versus photocurrent characteristics as shown below in FIG. 4, due to which the current flow in the system 100 varies depending upon the instantaneous ambient light level.

FIG. 5 illustrates the system 100 with multiple sensors and auxiliary, according to an exemplary embodiment of the present invention. Based on the above discussed photodiode characteristics of the chip based sensors, the system 100 is configured using multiple sensors and auxiliary resistances to provide a highly sensitive and precise ambient light sensing bank i.e., sensor bank 110. The system 100 is capable of generating varying DC voltages depending upon the prevailing ambient light situation. A combination of two sensors or sensor chips may be used to form a sensor bank 110, both operating over exclusive ambient light levels which may doubles the accuracy of their sensing capability over the entire daylight, for example, greater than 600 lux, to dark condition, for example less than 10 lux.

As explained above, with the change in ambient light falling on the sensor banks 110, the photocurrent flowing through the sensors 112 and 114 changes as per the above explanation in FIG. 4, which in turn changes the current flowing through the sensing resistors creating a varying DC voltage output. Out of the two DC voltage outputs V1 and V2, V1 may be calibrated using suitable sense resistor values, to operate from greater than 600 lux condition to 350 lux condition, this is the high ambient sensor 112. Whereas V2 may be calibrated to operate from 350 lux to less than 10 lux condition, this is the low ambient sensor 114. This configuration may create adequate variance in DC voltage (approx 0.1Vdc), as shown in TABLE 1 below, even for a change of just 10 lux which may be easily captured at the micro-controller 130. This configuration of using multiple sensor banks 110 highly increases the sensitivity and precision of the system 100 and makes the system 100 capable of differentiating ambient light condition like full daylight, overcast day, dark day, very dark day, twilight, deep twilight and even more. The high light level detection sensor 112 may be functional for conditions like direct sunlight, full daylight and overcast day while the low light level detection sensor 114 may be functional for conditions like dark day, very dark day, twilight and deep twilight or no light.

TABLE 1

| | | Voltage input to |
|---|---|---|
| Ambient Light level | | microcontroller |
| (in lux) | Operating Sensor | (in V DC) |
| Below 10 | Sensor 2 | 5.0 |
| Completely dark. Full | (Low Ambient | |
| light output from | Sensor) | |
| Luminaire | | |
| 10 (twilight) | | 4.9 |
| 50 | | 4.5 |
| 100 | | 4.0 |
| 150 | | 3.5 |
| 200 | | 3.0 |
| 250 | | 2.5 |
| 300 | | 2.5 |
| 350 | Sensor 1 | 2.9 |
| 400 | (High Ambient | 3.3 |
| 450 | Sensor) | 3.7 |
| 500 | | 4.1 |
| 550 | | 4.5 |
| 600 | | 4.9 |
| Above 600 | | >4.9 |
| Sufficient ambient | | |
| light. No light output | | |
| from Luminaire | | |

Referring to FIG. 6 which illustrates a plurality of sensor banks 110 banks adapted to build in a redundancy which further enhances the longevity of the system 100, according to an exemplary embodiment of the present invention. To build in a redundancy a plurality, for example two, such sensor banks 110 may be used. A micro-controller polling algorithm (also referred to as ‘polling module’) is adapted to sens both the sensor banks 110 inputs and averages out the values to determine the required duty cycle of the pulse width modulated specific light output of the illuminating equipment. The same input DC voltages may be used to switch ON and OFF the illuminating equipment based on ambient light. The two sensor banks 110 may work exclusive to each other and adds redundancy to the system 100. In case one bank 110 fails, the micro-controller 130, using its intelligent polling module to detects the defective bank 110, as it would return ZERO DC voltage to the analog pins of the micro-controller 130 and operates on basis signals received from the working sensor bank 110. Moreover when both the sensor banks 110 are working fine, the micro-controller 130 may uses signals from both the sensor banks 110 and averages out the results before making a decision. A power supply unit 10 may be used to supply the power to the system 100.

According to an exemplary embodiment of the present invention, this type of high precision sensing capability along with the micro-controller 130 with polling module as discussed earlier helps to build in further intelligence into the lighting systems by allowing powering up of the lights partially to specific percentage levels based on the actual demand of the prevailing ambient light conditions which considerably adds to power saving methodologies.

Referring to FIG. 7 which illustrates a micro-controller, according to an exemplary embodiment of the present invention. The microcontroller 130 may be an enhanced flash-based 8-Bit CMOS Micro-controller with nanoWatt Technology. It has a 256 bytes EEPROM non-volatile memory which is used to store the comparison table of the analog dc voltage input (ambient light level) versus the duty cycle output (percentage illumination) of the pulse width modulated output which is illustrated in the below TABLE 2. The micro-controller 130 may further have a non-volatile program memory of e.g. 256 KB, which may be loaded with an algorithm, used to monitor, process, compute, and control the automated ON/OFF and dimming functionality in a intelligent manner.

The additional advantage achieved using the principals or applications of the present invention is that the present invention may cater to the varying customer requirements round the world requiring different percentage dimming versus ambient light relationship without any design modifications but by just modifying the corresponding values of column 3 in the below TABLE 2.

TABLE 2

| Voltage at analog | Voltage at analog | |
|---|---|---|
| input from LOW | input from HIGH | PWM Duty |
| Ambient Sensors | Ambient Sensor | Cycle |
| (in Vdc) | (in Vdc) | (in %) |
| >4.9 | — | 100 (Full ON) |
| 4.5-4.9 | — | 95 |
| 4.0-4.5 | — | 85 |
| 3.5-4.0 | — | 75 |
| 3.0-3.5 | — | 65 |
| 2.5-3.0 | — | 55 |
| — | 2.5-2.9 | 45 |
| — | 2.9-3.3 | 35 |
| — | 3.3-3.7 | 25 |
| — | 3.7-4.1 | 15 |
| — | 4.1-4.5 | 10 |
| — | 4.5-4.9 | 5 |
| — | >4.9 | 0 (Full OFF) |

Referring to FIG. 8 which is a flow graph of a method 200 for controlling the ON/OFF modes and dimming functionality, according to an exemplary embodiment of the present invention. From FIG. 8, it is evident that putting the micro-controller 130 in the system 100 imparts a lot of intelligence into the sensor based ON/OFF and dimming system 100. The method 200 comprises the steps of initialising a data memory and digital and analog pins at a step 210 after the micro-controller 130 powerup at a step 205, running polling module at a step 220, checking the working of the sensor banks 110 at a step 240, initialising and switching to time based dimming at a step 260 in case the sensor bank 110 is not working, running a sampling module at a step 280 if the sensor bank 110 is working, and then repeating the loop by running the polling module at the step 220. The polling module, sampling module, and the time based algorithm (also referred to as ‘time based module’ or ‘time based dimming algorithm’) are the intelligent algorithms or computing logics. The polling module is adapted to detect the conditions of the sensors 112 and 114 and building redundancy. The sampling module adapted to control light output based on detected ambient light conditions and ambiguous false detections conditions. The time based module is adapted to use as disaster recovery in case of failure of the chip sensors 112 and 114.

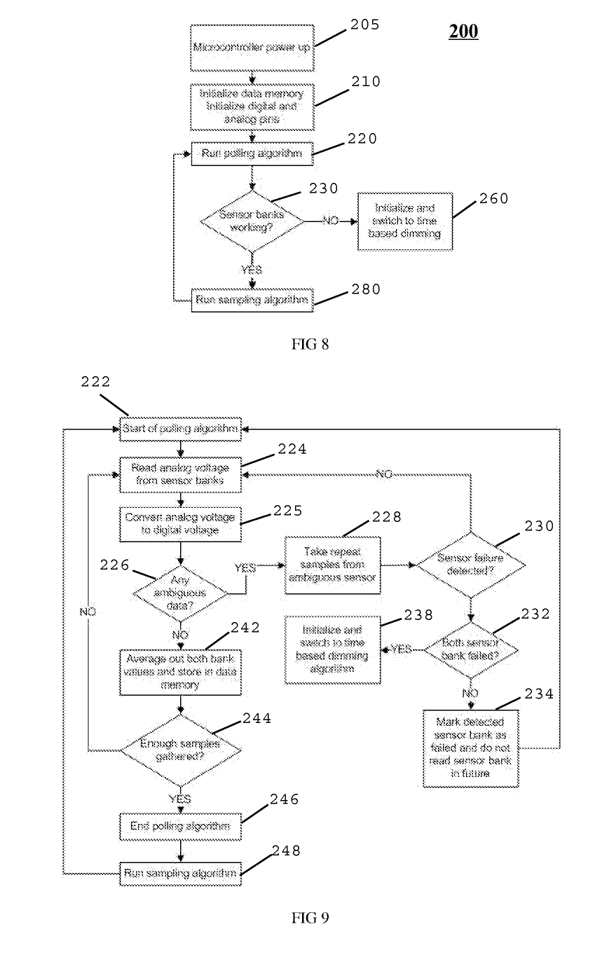

Referring to FIG. 9 which illustrates functioning of the polling module used for detecting the conditions of the sensors 112 and 114 and building redundancy into the chip sensor 112 and 114 based ON/OFF and dimming capability. On start of the polling module at a step 222, the microcontroller 130 first reads the analog voltage signals coming from both the sensor banks 110 at a step 224 and converts them to digital voltage signals at a step 225 using its internal analog to digital conversion method. This digital voltage is actually a representation of the prevailing ambient light [TABLE 1] and only changes if there is a change in the ambient light. Then this digital voltage is checked at a step 226 if it is a relevant voltage within limits [TABLE 1] or is an ambiguous data out of limits. In case it is found ambiguous data, the prior steps are repeated to check if it is giving repeated ambiguous data, i.e., repeat samples are taken from an ambiguous sensor at a step 228 then sensor bank 110 failure detection is checked at a step 230 and 232. If no sensor bank failure detected at the step 230 then the microcontroller 130 again reads the analog voltage signals coming from both the sensor banks 110 at the step 224. In case repeated ambiguous data is received from any of the sensor bank 110, the microcontroller 130 marks the sensor bank 110 to be failed and does not read the particular sensor bank 110 in future at a step 234. In case one sensor bank 110 is failed, the algorithm still works the same way without fail using the remaining sensor bank 110. This is how the redundancy is built into the chip sensor based on/off and dimming system where the two sensor banks work exclusive to each other and provides a much longer life to the system. In case both the sensor banks 110 are detected failed at the step 234, the microcontroller 130 switches to time based module at a step 238 and the polling module is no more in function. In case no ambiguous is found at the step 226, the microcontroller 130 then averages out the digital voltages read from the sensor banks 110 and stores the data in its internal memory at a step 242. Then the microcontroller 130 checks at a step 244 if enough samples are collected over 15-20 seconds or not. Until enough samples are not collected, it keeps on gathering such digital voltages and keeps on storing them in its internal memory at the step 244. Once enough samples are collected, the microcontroller 130 ends the polling module at a step 246 and starts the sampling module at a step 248 used for controlling light output based on detected ambient light conditions and also removing ambiguous false condition detections.

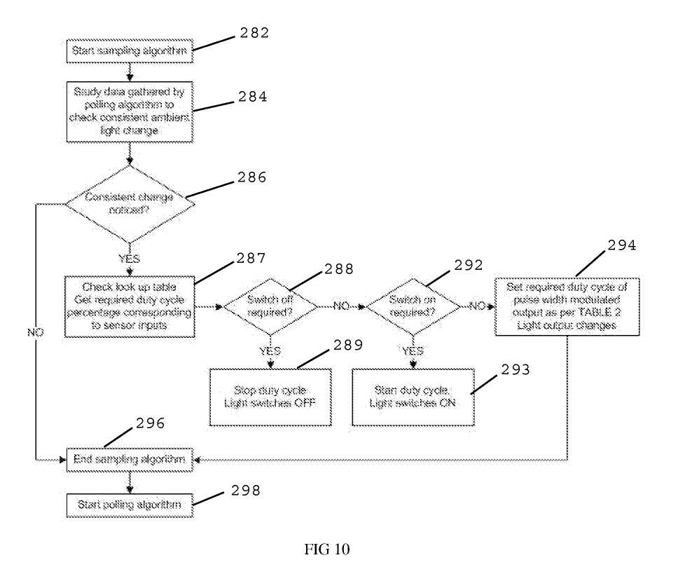

Referring to FIG. 10 which is a flow diagram illustrating functioning of the sampling module used for controlling light output based on detected ambient light conditions and also avoids ambiguous false detections conditions, according to an exemplary embodiment of the present invention. After the polling module is completed, the microcontroller 130 starts the sampling module at a step 282 which first studies all the data samples collected and stored in the internal memory during the polling module to check consistent ambient light change at a step 284. The data is studied at a step 284 to see if all the samples collected and stored show a consistent change in the digital voltage which refers to a consistent change in the ambient light at a step 286. Check lookup table and get required duty cycle percentage corresponding to sensor 112 and 114 input at a step 287. This mechanism helps to detect false conditions or momentary ambient light changes caused due to situations like passing clouds, flying objects etc. If it is a momentary change, then the data samples collected and stored by the polling module would not be similar to each other and hence the micro-controller 130 may not realize that it is not a consistent change and therefore would ignore the situation and go back to the polling module without any change to the light output of the luminaire. But if it is actually a change in the ambient light, the collected and stored data samples would show consistency. The microcontroller 130 may then at a step 294 refer to the voltage versus duty cycle table [TABLE 2] stored in the non-volatile memory of the micro-controller 130 and know the actual duty cycle that needs to be set. Once the duty cycle is set, the light output of the luminaire would change accordingly and the microcontroller 130 may then end the sampling module at a step 296 and restart the polling module at a step 298. If, at a step 288 switch OFF is required, then at a step 289 duty cycles stopped and light switches OFF. If at the step 292 switch ON is required then at a step 293 duty cycles start and light switches ON.

The timing based module is illustrated below with an example. If we consider that today [DAY 1] the sensors 112 and 114 are functional the timing data logged in the data memory would look like as shown in below TABLE 3.

TABLE 3

| PWM Duty | |
|---|---|
| Cycle | Time tagged in memory |
| (in %) | on DAY 1 |
| Light switches | T0 = 0 hrs 0 min |
| ON | |
| 5% | T1 = T0 + 10 min |
| 15% | T2 = T0 + 20 min |
| 25% | T3 = T0 + 40 min |
| 35% | T4 = T0 + 55 min |
| 45% | T5 = T0 + 1 hr 15 min |
| 55% | T6 = T0 + 1 hr 30 min |
| 65% | T7 = T0 + 1 hr 50 min |
| 75% | T8 = T0 + 2 hr 10 min |
| 85% | T9 = T0 + 2 hr 40 min |
| 95% | T10 = T0 + 3 hr 0 min |
| Light full ON | T11 = T0 + 3 hr 30 min |
| 100% | |
| Light switches | T12 = T0 + 8 hr 10 min |
| OFF | |
| Light OFF | T13 = 15 hrs 50 min |
| duration | (i.e. 24 hrs-8 hr |
| | 10 min) |

If for some reason all the sensors 112 and 114 are detected as failed sometime after DAY 2 operation. The micro-controller 130 immediately initializes and switches to time based module. The micro-controller 130 fetches the instantaneous data of the real time clock and finds that 10 hours have passed since the light switched OFF yesterday. Therefore, the timing based module calculates that the light should switch ON after another 5 hours and 50 minutes. Then set duty cycle to 5% after 10 minutes, 15% after 20 minutes and so on till it switches OFF after 15 hours and 50 minutes of operation. Since the timing based module may continue to supersede the ambient light based algorithm the light would again work on DAY 3, DAY 4 and keep on working based on the stored time tags till the system 100 is replaced.

According to an exemplary embodiment of the present invention, firstly the chip based sensors 112 and 114 may be connected to at least an analog input of the micro-controller 130 which is programmed to generate a digital pulse width modulated signal with varying duty cycle based on a voltage levels received on the analog pins. By the fundamental characteristics of the chip sensors 112 and 114, the internal resistances of the sensors 112 and 114 change with the amount of light exposed on the sensors 112 and 114 due to which the sensors 112 and 114 may allow an increased or a decreased current flow in the system 100. The increase or the decrease in the current flow is then may be converted to increased or decreased voltage drop across resistance packs connected in series which may be reflected at the analog pins of the micro-controller 130. The micro-controller 130 may works on a polling module which may constantly monitors the voltages on its analog pins. When the micro-controller 130 senses a change in the voltage at the analog pins, the micro-controller 130 may compare the change in the voltage with a duty cycle versus voltage table which may be pre-programmed in an algorithm fed into the micro-controller 130. Based on the duty cycle value, the micro-controller 130 may puts out a pulse width modulated signal from one of its digital pins with the desired duty cycle. In a full glow condition which is when it is completely dark, a duty cycle is 100% and in case of full off condition which is when it is full daylight, the duty cycle is 0%. Moreover, in OFF condition, the micro-controller 130 may also puts out a high digital signal from the digital port which may switches OFF the entire circuit on a parent card further reducing the OFF condition energy consumption.

According to an exemplary embodiment of the present invention, the system 100 and the method 200 is capable of: implementing sensor redundancy on each illuminating equipment; providing an increased MTBF [Mean Time Between Failure] of the photo sensor based control; eliminating the use of expansion metal relays; reducing operational costs by implementing redundancy which reduces the demand for sensor replacements; increasing the capability of the photo-sensor units from just controlling the ON/OFF functionality to ambient light based dimming capability; increasing power savings of outdoor illuminating equipments not only by changing it to solid state lighting but also by lighting them at different percentages (i.e. dimming) as required based on the condition of the ambient light; making the photo sensors 112 and 114 highly sensitivity and precise to ambient light by using sensor banks 110 (i.e. combination of photo sensors 112 and 114) to maximize the power saving capability; implanting intelligence into the outdoor lighting system to make it capable of taking decisions based on various built in complex algorithms.

According to an exemplary embodiment of the present invention, an additional backup/redundancy is provided as a result of the ON/OFF and dimming pattern which gets stored in the micro-controller 130 memory from prior operations, wherein the stored result of the ON/OFF and dimming pattern automatically retrieved in the event all sensors 112 and 114 are blocked or non-operational and the micro-controller 130 starts operating the illuminating equipment in the same manner so that by the time the sensors 112 and 114 are replaced the light is still functional.

Although a particular exemplary embodiment of the present invention has been disclosed in detail for illustrative purposes, it will be recognized to those skilled in the art that variations or modifications of the disclosed invention, including the rearrangement in the configurations of the parts, changes in sizes and dimensions, variances in terms of shape may be possible. Accordingly, the invention is intended to embrace all such alternatives, modifications and variations as may fall within the spirit and scope of the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. A system for intelligently controlling the ON/OFF modes and dimming functionality for lighting devices with built in redundancy, comprising:
at least a sensor bank having a plurality of sensors capable of operating over exclusive ambient light levels and creating redundancy;
at least a micro-controller configured to add dimming functionality and automatically detecting faulty sensing situations and sudden change in the light level;
a polling module capable of detecting the conditions of the sensors and building redundancy; and
a sampling module capable of controlling light output based on detected ambient light conditions and ambiguous false detections conditions,
wherein a time based dimming module is capable of working as disaster recovery in case of failure of all sensors, wherein the micro-controller uses the sampling module to average out the results captured over a period of approximate 15-30 seconds to remove all possibilities of false reading captured due to sudden light level changes.

2. The system of claim 1, wherein the micro-controller and the polling module are capable of allowing powering up of the lights partially to specific percentage levels based on the actual demand of the prevailing ambient light conditions.

3. The system of claim 1, wherein a first DC voltage outputs (V1) is calibrated using suitable sense resistor values to operate from greater than 600 lux condition to 350 lux condition, wherein a second DC voltage outputs (V2) is calibrated to operate from 350 lux to less than 10 lux condition, wherein the same input DC voltage is used to switch ON and OFF the illuminating equipment based on ambient light.

4. The system of claim 1, wherein a high light level detection sensor is functional for conditions including any one of direct sunlight, full daylight and overcast day, wherein a low light level detection sensor is functional for conditions including any one of dark day, very dark day, twilight and deep twilight or no light.

5. The system of claim 1, wherein the micro-controller with the help of the polling module is capable of sensing inputs of sensor banks and averages out the values to determine the required duty cycle of the pulse width modulated specific light output of the illuminating equipment.

6. The system of claim 1, wherein in case of failure of one sensor bank, the micro-controller is capable of detecting the defective sensor bank and accordingly discarding ambiguous situations that might arise due to the failure.

7. The system of claim 1, wherein the micro-controller have a non-volatile program memory which is loaded with an algorithm, used to monitor, process, compute, and control the automated ON/OFF and dimming functionality in a intelligent manner.

8. The system of claim 1, wherein an additional backup/redundancy is provided as a result of the ON/OFF and dimming pattern which gets stored in the micro-controller memory from prior operations, wherein the stored result of the ON/OFF and dimming pattern automatically retrieved in the event all sensors are blocked or non-operational and the micro-controller starts operating the illuminating equipment in the same manner so that by the time the sensor is replaced the light is still functional.

9. The system of claim 1, wherein the sensors are connected to at least an analog input of the micro-controller that is programmed to generate a digital pulse width modulated signal with varying duty cycle based on a voltage levels received on the analog pins.

10. The system of claim 1, wherein the micro-controller works on a polling module which is capable of constantly monitoring the voltages on analog pins of the micro-controller.

11. The system of claim 1, wherein when the micro-controller senses a change in the voltage at the analog pins the micro-controller compare the change in the voltage with a duty cycle versus voltage table is pre-programmed in an algorithm fed into the micro-controller, wherein based on the duty cycle value the micro-controller puts out a pulse width modulated signal from one of it's digital pins with the desired duty cycle.

12. The system of claim 1, wherein multiple sensors and auxiliary resistances are adapted to configure the sensor bank.

13. A method for intelligently controlling the ON/OFF modes and dimming functionality for lighting devices with built in redundancy, comprising the steps of:
initializing a data memory and digital and analog pins;
running polling module;
initializing and switching to time based dimming in case the sensor bank is not working; and
running a sampling module if the sensor bank is working,
wherein the polling module is capable of detecting the conditions of the sensors and building redundancy, wherein the sampling module is capable of controlling light output based on detected ambient light conditions and ambiguous false detections conditions, wherein the time based module is adapted to used as disaster recovery in case of failure of the sensors.

14. The method of claim 13, wherein the polling module comprising the steps of:
reading analog voltage signals coming from sensor banks and converting the analog voltage signals to digital voltage signals;
checking digital voltage;
checking sensor bank failure detection;
marking the failure sensor bank for not reading failed sensor bank further;
reading the working sensor bank in order to built the redundancy;
switching to time based module if both sensor banks are failed;
averaging out the digital voltages read from the sensor banks;
storing the data in internal memory of the micro-controller;
checking whether desired samples are collected over 15-20 seconds or not;
terminating the polling module in case desired samples are collected; and
starting a sampling module for controlling light output based on detected ambient light conditions and also removing ambiguous false condition detections.

15. The method of claim 13, wherein the sampling module further comprising the steps of:
studying all the data samples collected and stored in an internal memory of the micro-controller during the polling module to check consistent ambient light change; and
setting an actual duty cycle by referring to a voltage versus duty cycle table stored in the non-volatile memory of the micro-controller.

16. A system for intelligently controlling the ON/OFF modes and dimming functionality for lighting devices with built in redundancy, comprising:
a plurality of sensor banks having a plurality of sensors capable of operating over exclusive ambient light levels and creating redundancy; and
a micro-controller configured to add dimming functionality and automatically detecting faulty sensing situations and sudden change in the light level,
wherein the system is embedded with computing logics with the help of a high end micro-controller to increase sensitivity of the system, wherein the system is capable of generating varying DC voltages depending upon the prevailing ambient light situation.

17. The system of claim 16, wherein the computing logics includes any one of a polling module, sampling module, time based dimming module or any combination thereof.

18. The system of claim 16, wherein the dimming functionality controls a light output of the illuminating equipments based on the amount of instantaneous ambient light level.

19. The system of claim 16, wherein the micro-controller is programmed for different percentage dimming versus ambient light relationship depending upon specific light level requirements, wherein the dimming functionality controls a light output of the illuminating equipments based on the amount of instantaneous ambient light level.

20. The system of claim 16, wherein accuracy of a control mechanism is increased by using the readings of multiple sensors.
